(19) United States
(12) Patent Application Publication
(10) Pub. No.: US 2022/0415289 A1
(43) Pub. Date: Dec. 29, 2022

(54) Mobile App riteTune to provide music instrument players instant feedback on note pitch and rhythms accuracy based on sheet music

(71) Applicant: Steve Cheng, Exton, PA (US)

(72) Inventors: Steve Cheng, Exton, PA (US); Daniel Cheng, Exton, PA (US)

(21) Appl. No.: 17/446,458

(22) Filed: Aug. 30, 2021

Related U.S. Application Data
(63) Continuation of application No. 17/356,471, filed on Jun. 23, 2021.

(51) Int. Cl. G10H 1/00; G10G 1/04; G10H 1/36; G06K 9/00; G06K 9/62

(52) U.S. Cl. CPC G10H 1/0008; G10G 1/04; G10H 1/36; G06K 9/00442; G06K 9/6217; G10H 2210/066; G10H 2210/071; G10H 2210/005; G10H 2210/086; G10H 2210/091

(57) ABSTRACT

A tool is needed for music instrument learners to get feedbacks on the correctness of their performances of a particular piece of music. The invention disclosed here is such a tool that can provide music instrument players instant feedback on note pitch and rhythms accuracy based on sheet music. This is accomplished through audio signal processing, sheet music image processing, and conversion of both analogue images and audio signals into standard digital music representation so a comparison can be done and hence a feedback can be presented to the player. An advanced feature will allow users to save the data to the cloud and retrieve later for comparison of progress. It also will allow user to participate an online competition with other players of the same piece of music.

### BACKGROUND

### The Technology Fields

OMR (Optical Music Recognition)

Audio signal processing and music transcription

The generic approach and method: Optical Music Recognition is experiencing great improvement due to recent machine learning progress. For our purposes here, we will use available machine learning training data and algorithm to build a practical model to convert sheet music, uploaded or scanned, to MusicXML format for storage and further on for comparison with MusicXML file generated from transcription of recorded audio file from instrument performance or uploaded performance recording.

On performance recording audio signal process, software solution will be used to parse audio signal frequencies, rhythms and other musical characteristics.

### BRIEF DESCRIPTION OF THIS INVENTION

Music students, especially, string instrument students, usually have hard time playing in tune or playing correctly following the sheet music. Accuracies are even more important for playing an excerpt from a certain piece of music for an important audition for students. The application riteTune is designed to help violin or other string instrument students to check their playing against the sheet music they are learning and trying to perform.

Basic functionalities should include checking audio recording against sheet music for intonation, rhythm. Advanced features can include tempo, dynamics, etc.

The challenges for implementing such a helpful tool can be big. However, with the advancement in the field of machine learning, Optical Music Recognition (OMR), and computerized audio signal processing, it is possible to accomplish such an ambitious goal.

The solutions are to take the advantages of the latest developments in machine learning and OMR to provide a machine learning based OMR to convert uploaded or scanned sheet music on the standard music to compare against and on the other hand, take the advantages in software advances in audio signal processing, like the development of AudioKit that is rich in audio signal processing software libraries.

The music format for comparison will be MusicXML which, when completed from both ends of stand sheet music and recorded music performance, will be easy to compare with, as music is digitized and marked up in tags.

### DETAILED DESCRIPTION OF INVENTION

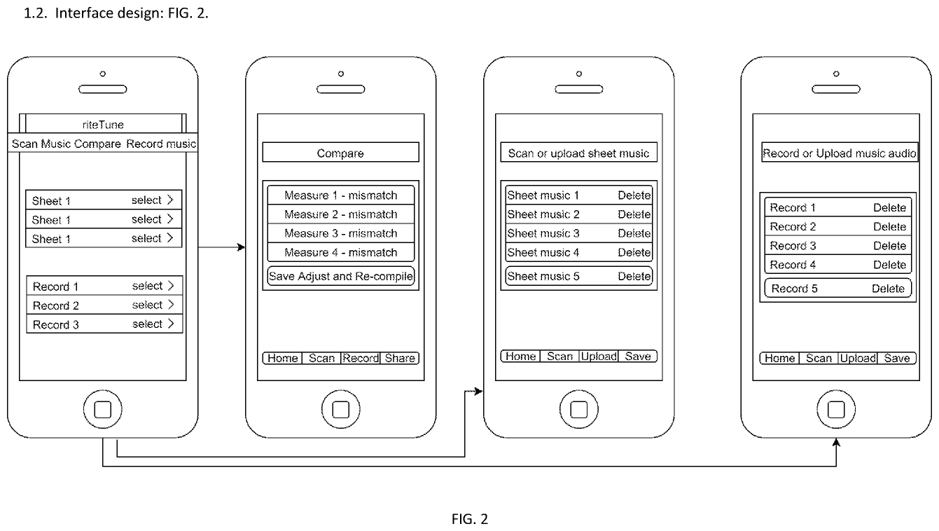

riteTune is an application that can help all levels of music players to compare recorded music performed against its original standard sheet music (see FIG. 2 in the diagrams document). This tool can be easily expanded to other musical instruments, even singing.

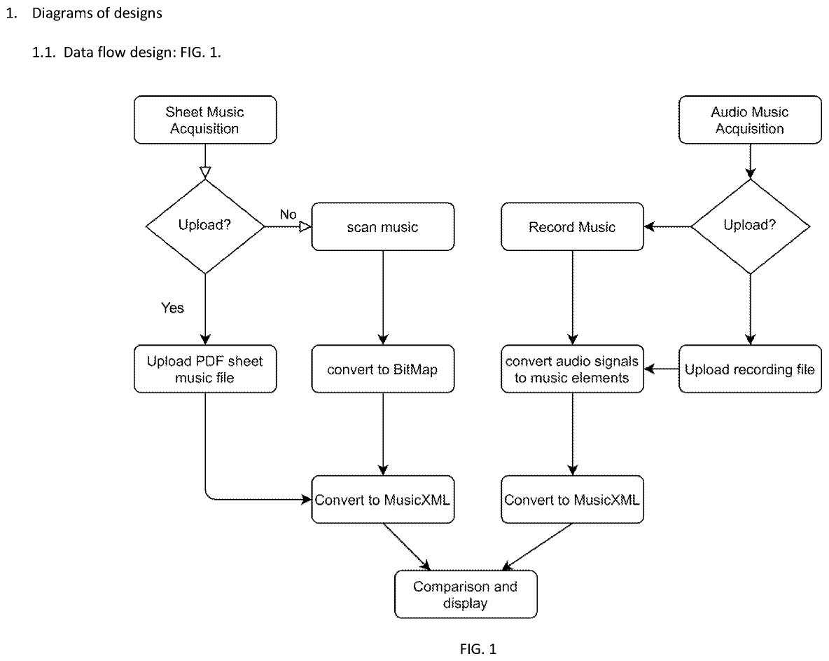

The application has three major parts (see FIG. 1 in the diagrams document): sheet music acquisition and processing, audio music acquisition and process, and music comparison and report presentation.

Sheet Music Acquisition and Processing

Sheet music can be acquired either by uploading of PDF or image files of the sheet music used as standard music to compare against.

Once sheet music file is available, it will be processed by a program using technics including but not limited to image segmentation, staff detection, notes isolation, musical notes recognition using trained pattern recognition from machine learning process.

The result file generated from note detection and reorganization will be processed and converted through the MusicXML engine to create the MusicXML file of the sheet music.

Audio Music Acquisition and Process

Audio music will be acquired through uploading of a musical file (MP3) or directly by recording through the device that riteTune is installed and running. The recording of the music will be integrated into the process at the same time. The musical file can be processed the same way as the recording music.

The music process involves using software library to analyze the frequency and the time of the audio signal and transcribing into music notations.

The result file generated from music notation transcribing will then be converted through the MusicXM L engine to create the MusicXM L file of the recorded music.

Music Comparison and Report Presentation

The MusicXML file of sheet music and corresponding MusicXML file of the recorded music will be compared through the Music Comparison Engine. A report will be generated as the result of the comparison.

The comparison report will be displayed on the device that the application of riteTune is installed and running.

### BRIEF DESCRIPTION OF DIAGRAMS

FIG. 1 in the diagrams document shows how data processing flows through the application. It shows how sheet music can be uploaded or scanned into the system and converted to MusicMXL format, while user's playing based on the sheet music can be uploaded or recorded to the system and also converted to MusicXML format, and then the two can be compared and displayed to the user for learning and evaluation purposes.

FIG. 2 in the diagrams document shows four (4) user interface screens of the application. It includes Login screen, Comparison, Music scan/upload and Music recording.

### STATEMENT ON THIS SUBSTITUTE SPECIFICATION

The substitute specification contains no new matter

The invention claimed is:

1. A method to acquire Violin audio signal through microphone built-in or attached to device like phone or PC where violin audio signal is acquired in varying sampling speed depending on music speed and the audio frequencies and timestamp and is further analyzed based on pitch and rhythm, compared to AI models, obtained from machine learning based on stored standard scores, to produce instantaneous musical notes in MusicXML, then recorded on the device for later usage of the application as depicted in diagram one point one.

2. A method to convert scanned or uploaded sheet music in image file to MusicXML using Optical Music Recognition (OMR) technology based on machine learning as depicted in diagram one point one.

3. A method to compare and display overlaid scores of music, with one from sheet music, and the other from recorded audio signal transcribed, to detect differences of two scores and highlight of differences by rhythm and pitch on the overlaid displays of musical scores, which, in advanced features, can include other differences in other musical features, like tempo, dynamics, as depicted in diagrams in the diagram file, based on a rating system using machine learning with data collected from all users, in which, solo sound tracks are extracted from an audio track of a performance with music accompaniment, using machine learning algorithm, that can produce a music accompaniment for playing along or Karaoke to practice against or play/sing along with.
